(19) United States
(12) Patent Application Publication
(10) Pub. No.: US 2005/0123651 A1
(43) Pub. Date: Jun. 9, 2005

(54) Mineral water composition

(76) Inventors: Young-Ho Hahn, Los Angeles, CA (US); Yin Ji Shan, Beijing (CN)

Correspondence Address: NATH & ASSOCIATES, 1030 15th STREET, NW, 6TH FLOOR, WASHINGTON, DC, 20005, US

(21) Appl. No.: 10/728,094

(22) Filed: Dec. 5, 2003

(51) Int. Cl. A23L 2/00

(52) U.S. Cl. 426/74; 426/66

(57) ABSTRACT

The present invention relates to a mineral water composition. More particularly, the present invention is directed to a mineral water composition which contains Sengmin Donglisu comprising various kinds of minerals, zinc hydrates and magnesium hydrates, which has therapeutic and cosmetic effects on human body.

### TECHNICAL FIELD

The present invention relates to a mineral water composition. More particularly, the present invention is directed to a mineral water composition which contains Sengmin Donglisu comprising various kinds of minerals, zinc hydrates and sodium hydrates, which has therapeutic and cosmetic effects on human body.

### BACKGROUND ART

Since early times, people have enjoyed taking a bath in mineral springs for the purpose of skin care, refreshing, relaxing effect on the human body. Especially, it has been known that active ingredients such as minerals, salts contained in mineral spring have various therapeutic effects on human body.

Minerals absorbed through fine pores on the skin, warm the human body and simulate blood circulation, thereby accelerating the flow of blood in peripheral vessels so as to enhance metabolism. They also promote perspiration to help the body excrete effete material.

Salts are deposited on the skin through taking a bath. The salt film which cover the skin keeps the body warm for a long time after bathing and serve as a heat insulator.

In addition to these effects, it has been known that taking a bath in mineral spring have some effect to clean and sterilize the skin together with curative effects for a variety of dermal and other diseases such as neuralgia, rheumatism, acne, eczema and psoriasis (Ma'or, Z., Magadassi, S., Effron, D., Yehuda, S Isr. J. Med. Sci. 32 (suppl 3), 28-35 (1996)).

The Dead Sea has been known as the richest natural mineral source in the world, with a concentration of 32% (w/v) dissolved minerals. It is fed mainly by River Jordan in the north and by perennial springs and streams from the east and west. Having no outlet, the Dead Sea is a “terminal lake” which loses large amounts of water by evaporation into the dry air.

This results in high concentrations of salts and minerals in a unique composition that is particularly rich in chloride salts of magnesium, sodium, potassium, calcium, and various others.

The specific feature caused by high concentration of salts and minerals in the Dead Sea is that human body floats on the sea due to the high specific gravity of the Dead Sea, which bring about a relaxation effect on human body.

However, the problem of mineral springs or Sea is that therapeutic effects are limited depend on the constitution of minerals specific to the geographical location. Further, lots of halogen ions in the Dead Sea, such as chloride and bromide, may cause harmful effect on human body.

In addition, it is not easy to access mineral springs which is located generally in the remote region faraway from the city

Accordingly, various kinds of bath preparations to be added on water to make mineral water composition which have therapeutic and cosmetic effects on human body, have been developed.

The conventional bath preparations known to public up to now, comprise various kinds of active ingredients in compliance with the specific object of their use, such as inorganic salts, inorganic acids, organic acids, medicinal herbs together with common additives such as a variety of natural essential oils, dyestuffs, perfumes, fats and oils, alcohols and so on.

The mode of action of such bath preparations and the efficacies varies depend on the kind of ingredients incorporated therein. Furthermore, bath preparations are even claimed to provide some psychological effects which can have a favorable influence on psychosomatic diseases by virtue of their colors and flavors.

In addition to the above conventional bath preparation, U.S. Pat. No. 4,970,072 discloses a bath preparation which comprises a whey concentrate of high mineral content, so that have benefits in the treatment of various disease and beautification.

However, it requires more complicated process to isolate the whey concentrate of high mineral content from the dairy product which contains many organic components such as lactose, casein, so that may be deteriorated in hot water, and cause unpleasant smell.

In addition, a bath additive composition disclosed in U.S. Pat. No. 5,397,497 contains oily or oil-containing component selected from the natural and synthetic, mineral, ethereal and fatty animal and vegetable oils, optionally a solvent and further auxiliaries and additives, which also have cosmetic and/or therapeutic activity.

However, the bath preparation which can provide highly concentrated mineral water composition on which human body can float so as to bring about relaxation effect on human body and also have cosmetic and therapeutic effect,. has not been developed until now.

Accordingly, the object of the present invention is to provide a mineral water composition which contains Sengmin Donglisu comprising high concentration of minerals and thereby bring about relaxation effect on human body.

Another object of the present invention is to provide a mineral water composition which further contains high contents of magnesium and zinc ions, and have a therapeutic effect on Diabetes, circulatory disease and stomach disease.

### DISCLOSURE OF INVENTION

The object of the present invention can be achieved by providing a mineral water composition which comprises Sengmin donglisu.

Sengmin Donglisu comprised in the mineral water composition of the present invention is a mixture of minerals which are extracted from the natural ores such as celestine, paigeite, vermiculite, limestone, mica, colorata and elvan.

Sengmin Donglisu of the present invention, is composed of more than twenty (20) kinds of minerals which are known to have effect on the physiological activities of human body.

Also, Sengmin Donglisu may be employed to make a drink water, which is effective on enhancing human immune system, promoting blood circulation, preventing and treating of the diseases such as diabetes, stomachic disorder and so on.

A more discussion in detail is fully described in Chinese patent application No.00121456.X which is incorporated by reference, including any drawings, as if fully set forth herein.

Another object of the present invention can be achieved by providing a mineral water composition which further comprises magnesium hydrates and zinc hydrates in addition to Sengmin Donglisu.

In this case, the concentration of magnesium ions may be 2.0% to 10.0% (w/v), preferably, 3.0% to 6.0% (w/v), and the concentration of zinc ions may be 1.0% to 5.0% (w/v), preferably, 2.0% to 4.0% (w/v). The specific gravity of this mineral water composition is 1.15 to 1.5.

Various magnesium hydrates which have good solubility and which can minimize an adverse effect on human body, may be employed in this mineral water composition to control magnesium ion content thereof. Magnesium hydrates that may be employed in the mineral water composition of the present invention, include magnesium sulfate hydrates, magnesium acetate hydrates, magnesium nitrate hydrates, magnesium chloride hydrates, magnesium bromide hydrates, etc. However, the above examples do not limit to the scope of magnesium hydrates which can be used in the present invention.

Similarly, various zinc hydrates can also be employed to regulate the zinc ion concentration of the mineral water composition after taking into consideration of solubility and of possible adverse effect on human body. Zinc hydrates that may be employed in the present invention, include zinc sulfate hydrates, zinc acetate hydrates, zinc nitrate hydrates, zinc bromide hydrates, etc. However, the above examples do not limit to the scope of zinc hydrates which can be incorporated in the mineral water composition of the present invention.

The mineral water composition of the present invention prepared by the process described above, can minimize the adverse effect on the human body and can float human body to provide psychological relaxation, and to enhance the homeostasis of human body.

Consequently, the self-regulative function of human body can be improved, which may lead the human body to the most effective condition for maintaining the physiological balance.

Moreover, the mineral water composition of which acidity is adjusted to pH 5.0-6.5, can serve as a functional bath water for alleviation of dermatitis, such as acne, and can also serve as a skin beautifier.

Best Mode for Carrying Out the Present Invention

Hereinafter, the present invention will be described in greater detail with reference to the following examples. The examples are given for illustration of the invention and not intended to be limiting the present invention.

### EXAMPPLE 1

Preparation of Mineral Water Composition

50 Kg of Zinc sulfate heptahydrates was dissolved in 100 kg of water and stirred for 2 hours at room temperature. 130 Kg of Magnesium sulfate heptahydrates and 20 Kg of Sengmin Dolisu were dissolved in 200 Kg of water and stirred for 3 hours at room temperature.

Two solutions thus obtained were mixed and stirred for 1 hour. Then 25 Kg of Sodium carbonate solution (16.7%) was added dropwise to the above mixture to produce yellow precipitate. The precipitate was filtered under vacuum to give 460 kg (95% yield) of minerals water composition with pH 6.0 and specific gravity 1.22.

The specific gravity of the mineral composition ranges from 1.15 to 1.5 and the acidity of the mineral composition is pH 5.5 to pH 6.5.

Furthermore, in order to increase the content of magnesium and zinc and to minimize the side effect, Zinc sulfate hydrates and Magnesium sulfate hydrates were added to the mineral water composition. The final composition thus prepared contains 2.0% (w/v)-10.0% (w/v) of magnesium, 1.0%-5.0% (w/v) of zinc, at least more than 1 ppm of Si, K, Mn, Fe, Ni, Cu, Sr, Y, Ba, Na, B and trace minerals.

### EXAMPPLE 2

The Change Of Blood Sugar Level

The mineral water composition prepared by the method described in Example 1 was poured in a bathtub and heated to 37° C.

Diabetic patients, who had not administrated hypoglycemics agent, have taken a bath in the mineral water composition of the present invention, for thirty (30) minutes for three times a week.

TABLE 1

| Blood | | | | | | | | | |
|---|---|---|---|---|---|---|---|---|---|
| Sugar | | | | | | | | | |
| level | 0 | 1 | 2 | 3 | 4 | 5 | 6 | 7 | 8 |
| (mg/d1) | week | week | weeks | weeks | weeks | weeks | weeks | weeks | weeks |
| Before | 360 | 290 | 273 | 270 | 255 | 233 | 186 | 164 | 140 |
| After | 310 | 255 | 242 | 225 | 198 | 203 | 153 | 123 | 112 |

As represented in Table 1, upon taking a bath in the mineral water composition of the present invention, the blood sugar levels were decreased gradually during the test period of 8 weeks. The result of Table 1 shows that bathing in the mineral water composition of the present invention bring about an effect of controlling the blood sugar level on Diabetic patients.

The Industrial Applicability

The minerals absorbed through fine pores on the skin during bathing in the mineral water composition of the present invention, warm the human body and accelerate flow of blood. Also, the minerals can promote perspiration to help the body excrete effete material. The acidity of the mineral water composition also has an antiphlogistic effect on the human skin.

Furthermore, magnesium, calcium and zinc ions of the mineral water composition absorbed in blood can activate insulin to convert glucose to glycogen to give a favorable effect on treating and preventing the diabetes by lowering the blood sugar level.

In addition, the floatage of human body occurred due to the high density of the mineral water composition of present invention can provide physical and psychological relaxation and enhance the homeostasis of human body. Consequently, the mineral water compositions can be used for the physical therapy and the rehabilitation therapy of patients suffering from the diseases related to muscle and nerve system.

While the present invention has been particularly shown and described with reference to a particular examples thereof, it will be understood by those skilled in the art that various changes and in form and details may be conceived there from without departing from the spirit and the scope of the present invention as defined by the appended claims.

1. A mineral water composition which comprises Shengming Donglisu.

2. The mineral water composition according to claim 1, which further comprises magnesium hydrates and zinc hydrates.

3. The mineral water composition according claim 2, wherein the concentration of magnesium ion is 2.0% to 10.0% (w/v) and the concentration of zinc ion is 1.0% to 5.0% (w/v).

4. The mineral water composition according to claim 1, wherein the specific gravity is 1.15 to 1.5 and the acidity is pH 5.0 to pH 6.5.
